(19) United States
(12) Patent Application Publication
(10) Pub. No.: US 2006/0061023 A1
(43) Pub. Date: Mar. 23, 2006

(54) Dual window preloaded engine bushing

(75) Inventor: Douglas L. Power, Kitchener (CA)

Correspondence Address: Timothy E. Nauman;Fay, Sharpe, Fagan, Minnich & McKee, LLP, 7th Floor, 1100 Superior Avenue, Cleveland, OH, 44114-2518, US

(73) Assignee: Cooper Technology Services, LLC

(21) Appl. No.: 10/943,635

(22) Filed: Sep. 17, 2004

(51) Int. Cl. F16F 9/00

(52) U.S. Cl. 267/140.11

(57) ABSTRACT

A vibration isolator is provided that can produce spring rate characteristics of a large preloaded engine bushing mount while also controlling mount excursions similar to those encountered with a smaller engine bushing mount. The isolator assembly improves isolator retention under dislodging forces such as those produced during bumper impact events.

### BACKGROUND OF THE INVENTION

This invention relates to a vibration isolator assembly, i.e., an assembly that absorbs vibrations and dampens relative movement between two structures. Examples of such assemblies include isolator mounts, bushing assemblies, cradle mount assemblies, etc. More particularly, this application is directed to a preloaded engine bushing mount and will be described with reference thereto. It will be appreciated, however, that the invention may have application in other vibration isolator assemblies or structures that encounter the same problems.

A vibration isolator assembly typically includes an external housing and an internal mounting shaft joined by an isolator formed from a vibration damping material such as a molded elastomer (e.g., rubber). The elastomer provides vibration isolation between the housing and the mounting shaft. Normally, the elastomer is molded to the housing shaft in a high-temperature molding operation. This provides a desirable bond between the elastomer and the housing shaft.

The inner mounting shaft is usually a rigid material, generally steel or aluminum, and the rubber isolator is received within the housing. Since it is often desirable to impart a degree of pre-compression onto the rubber isolator, the shapes and dimensions of the isolator and the housing are designed such that the isolator can be retained within the housing during service, and without the use of adhesives or other similar materials. Thus the pre-compression retains the rubber isolator within the housing, provides desired spring rate characteristics, and also improves durability.

In some arrangements, the housing is designed as a two-piece assembly. The isolator is placed within a first portion of the housing and the second portion of the housing is assembled and secured to the first housing portion, providing the desired pre-compression. In other instances, it is deemed more economical to design the housing as a one-piece component. In such a case, the rubber isolator is assembled through a window or opening in the housing. As the rubber isolator is larger than the opening in the housing, the opening is limited as to how much smaller it may be than the rubber before the process or assembly, or forcing the rubber through a smaller opening, imparts damage to the rubber.

The size of the opening in the housing also serves to limit the maximum displacement of the isolator shaft of the assembled bushing. This travel limiting feature is important, particularly in motor vehicle applications where packaging space under the hood is limited and a particular design requires that a travel limit be established. Usually the limit of travel is fixed by the inner mounting shaft movement relative to the wall defining the opening of the housing.

For design and tuning flexibility, significant variation in the spring rate characteristics of the isolators may be required. For example, in certain designs, it is desirable to reduce the dynamic rates and soften the mounts. To achieve this, it is common knowledge that a higher volume of rubber is needed in the isolator. This is often achieved by merely scaling up the isolator, that is, enlarging the components in a scaled-up version which results in a greater amount of rubber in the assembly. Because the isolator is necessarily larger, it becomes necessary to enlarge the opening in the housing and likewise the interior dimensions of the housing. The rubber is molded separately from the housing and then inserted into the housing window or opening to assemble and retain the isolator therein.

Merely enlarging the structure results in an extended travel excursion of the power train when mounted to the isolators. As noted above, the extent of travel limit relates to the inner metal shaft piece bottoming out on a rim of the housing opening. Thus, if the design maintains the same size shaft from the original bushing mount assembly for use with the scaled-up rubber isolator in order to incorporate extra rubber into the assembly, the resultant tradeoff is that extra travel of the power train will result. This, of course, could be an issue where only a limited amount of travel is permitted by the design.

One proposed solution was to expand the shaft size. This is perhaps best represented by FIGS. 1 and 4 where the typical pre-loaded engine bushing mount has a small rubber dimension and a small shaft. As represented by the reference arrow in FIG. 4, the travel is limited using a small rubber isolator and a small shaft.

FIGS. 2 and 5 illustrate the larger rubber design accommodated in an enlarged window in an external housing (not shown) and that still used a smaller shaft. The size of the rubber isolator is increased, i.e., the opening in the housing is enlarged in the height direction, to increase the amount of rubber in the assembly. This resulted in a noticeable increase in the amount the mounting shaft can travel before engaging the housing opening as represented by the reference arrow. Unfortunately, this excursion or travel of the power train is undesirable.

In FIGS. 3 and 6, one proposed solution was to increase the size of the shaft while maintaining the enlarged rubber isolator shape. FIG. 6 illustrates how the travel excursion is limited to a small height by incorporating a large shaft into the large opening of the housing. Unfortunately, this proposed solution removes portions of the rubber isolator that were otherwise desired. Thus, although this arrangement would limit the travel to ranges originally achieved with the design of FIG. 1, this solution resulted in the removal of the additional rubber that was desired to make the isolator softer. Therefore, although the larger rubber isolator and larger shaft assembly addressed the travel limit issue, this combination still resulted in a larger, more costly arrangement that still did not adequately address the desire for additional rubber and resultant soft performance characteristics, i.e., softer rate, while still limiting travel.

As noted with respect to FIGS. 1-6, part of the concern with vibration isolators was to limit the travel of the shaft relative to the housing. Accordingly, a need exists for a design that overcomes these problems and others in an economical, simple manner.

### SUMMARY OF THE INVENTION

A vibration isolator assembly is provided that satisfactorily incorporates additional rubber into the isolator while limiting travel excursion of the shaft.

A preferred embodiment of the vibration isolator assembly includes a rubber isolator received around the shaft and a housing having a cavity with first and second different windows or openings at opposite ends thereof.

The first and second openings are preferably different sizes.

In the preferred arrangement, the openings are similarly configured.

The rubber isolator is dimensioned to be inserted through the enlarged, first opening and advanced toward the smaller, second opening. The housing is sized relative to rubber isolator to impart a pre-compression to the isolator.

The vibration isolator assembly is also preferably oriented so that the first and second openings are arranged to counteract dislodging forces exerted thereon.

A primary benefit of the invention is the ability to incorporate additional rubber into the isolator while still controlling relative travel of the shaft with respect to the housing.

Another benefit is offered by orienting the bushing/isolator so that outside forces tend to push the isolator toward the smaller opening.

Still another feature of the invention is the ability to pre-compress the isolator, add additional rubber, control the travel limit, and do so in a cost effective manner.

Still other benefits and advantages of the invention will become apparent to those skilled in the art upon a reading and understanding of the following detailed description.

### BRIEF DESCRIPTION OF THE DRAWINGS

FIG. 1 is a prior art arrangement of portions of a vibration isolator assembly or bushing, namely a rubber isolator and mounting shaft thereof.

FIG. 2 is similar to FIG. 1 with an enlarged rubber volume (shown as an increased height of rubber) used with the same size mounting shaft of FIG. 1.

FIG. 3 illustrates portions of a vibration isolator incorporating an enlarged rubber isolator like FIG. 2 and also an enlarged mounting shaft.

FIG. 4 shows the structure of FIG. 1 received in a housing.

FIG. 5 shows the embodiment of FIG. 2 mounted in a housing.

FIG. 6 shows the embodiment of FIG. 3 mounted in a housing.

FIG. 7 is a perspective view of a vibration isolator housing incorporating a large and a small opening with a shaft shown extending therethrough.

FIG. 8 is an elevational view of the housing of FIG. 7 illustrating the small housing window or opening.

FIG. 9 is an elevational view taken from the other end of the housing and illustrating the large window or opening.

FIGS. 10 and 11 are perspective and elevational views of the rubber cushion or isolator that receives a central mounting shaft.

### DETAILED DESCRIPTION OF THE INVENTION

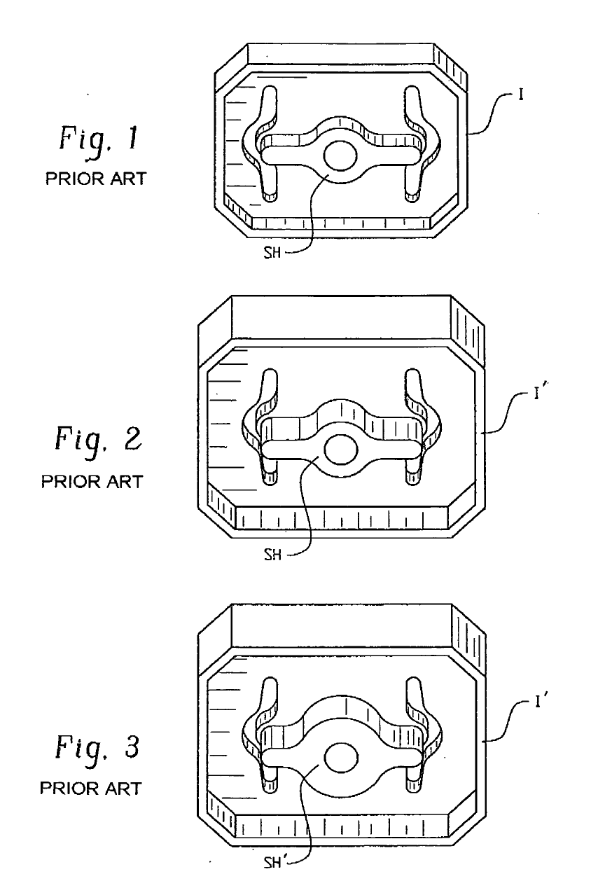

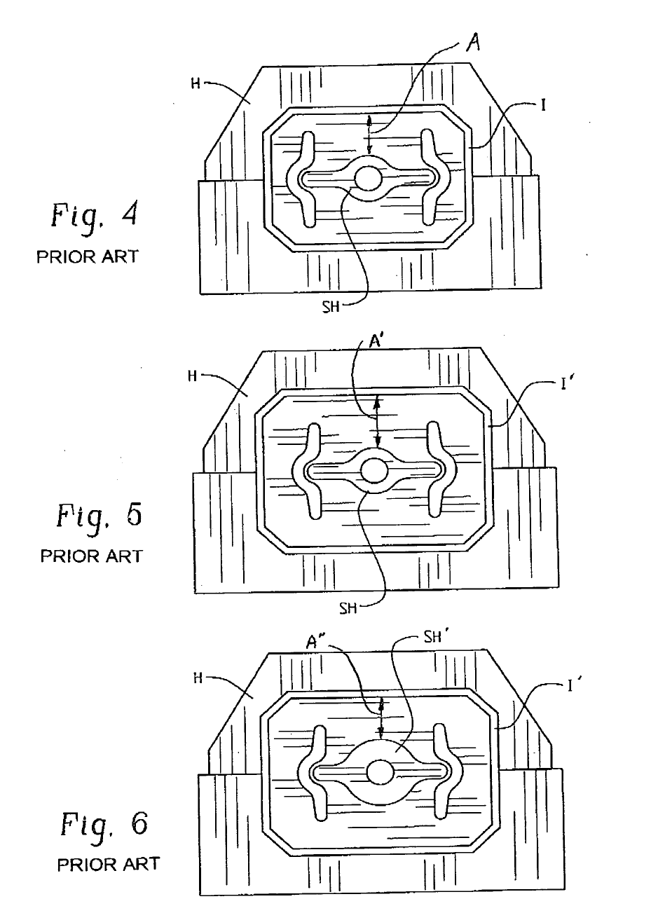

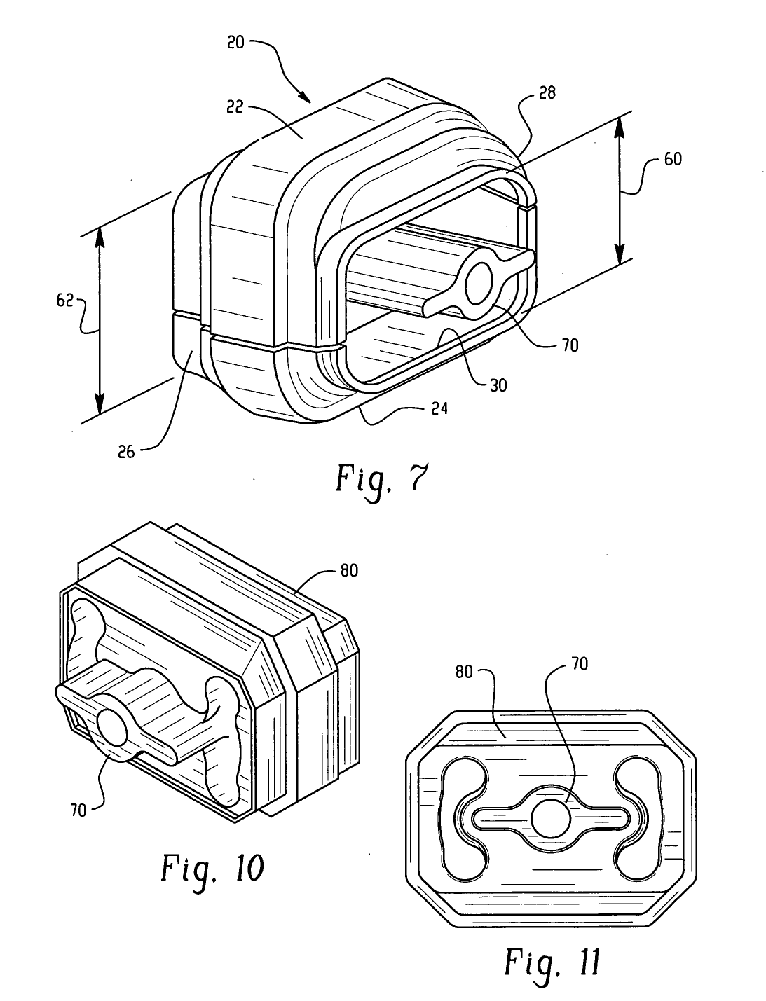

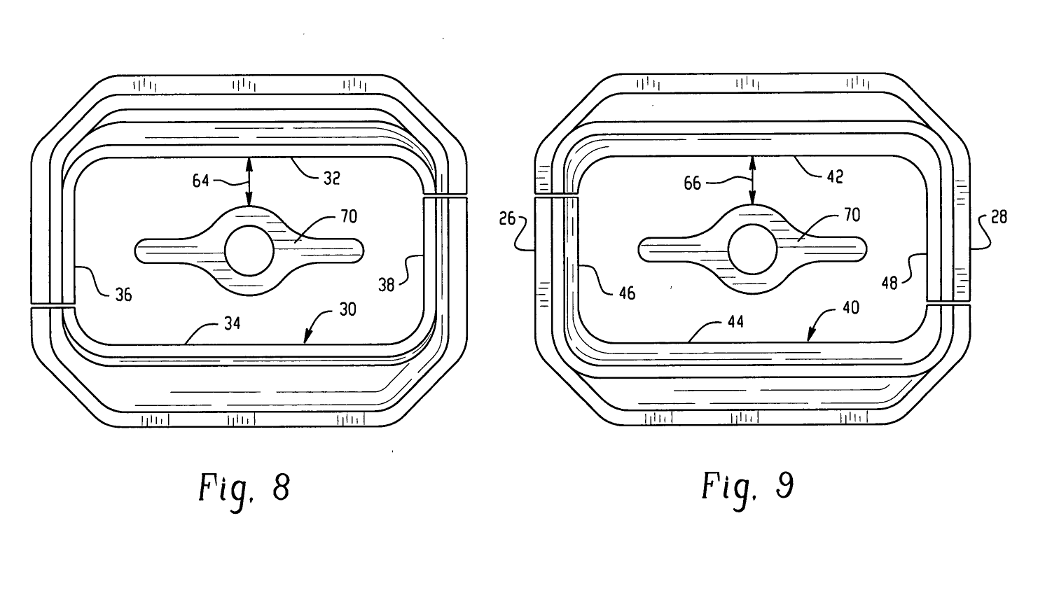

With the above description of FIGS. 1-6 as background for the terminology and problems associated with known vibration isolator assemblies, FIGS. 7-9 illustrate a preferred embodiment of the present invention or vibration isolator assembly or bushing that includes a housing 20 that addresses the need for increased rubber while limiting travel of the mounting shaft. Particularly, the housing can adopt a wide variety of shapes or configurations other than the hollow generally rectangular conformation shown in these figures. The housing includes a first or upper wall 22, a second or lower wall 24, a third sidewall or left sidewall 26 and a second sidewall or right sidewall 28. A first or smaller window or opening 30 in the housing is shown in FIGS. 7 and 8. Specifically, the smaller opening 30 in the housing includes first and second upper and lower walls 32, 34, respectively, and third and fourth or left and right sidewalls 36, 38, respectively. Similarly, a larger window or opening 40 includes first and second or upper and lower internal walls 42, 44, respectively, and third and fourth walls or left and right sidewalls 46, 48, respectively.

For ease of illustration and understanding, the primary distinction between the dimensions of the large and small windows is related to the height of the internal sidewalls. This is represented in FIG. 7 by the dimensions 60 and 62. It will be appreciated that the height 60 of the smaller opening is substantially less than the height 62 of the large opening. The small opening 30, in turn, results in a more limited extent of travel, as represented by reference numeral 64 in FIG. 9, where mounting shaft 70 (illustrated here for ease of understanding the travel limit concept) would engage the internal wall defining the small opening (shown here as the upper wall 32). It will be appreciated that in this symmetrical arrangement, the same extent of travel of the mounting shaft in the opposite direction (downward as illustrated) would result in the mounting shaft abutting against the lower wall 34.

On the other hand, dimension 66 in FIG. 9 represents the length of travel that the shaft would otherwise be permitted to move before-the upper or lower wall 42, 44 associated with the larger opening would be engaged by the mounting shaft. This is substantially greater than the travel distance 64 and thus, as will be appreciated, does not occur since the mounting shaft will engage the internal wall of the smaller opening.

Nevertheless, by providing the enlarged opening, additional rubber 80 that is bonded to the mounting shaft 70 (FIGS. 10 and 11) is incorporated into the isolator assembly. Using different sized openings limits the maximum travel of the shaft before engaging the internal wall of the enlarged opening.

The rubber isolator and a portion of the housing are both scaled up to the desired larger size needed to achieve the technical goals of rate characteristics and/or durability. The entire housing, though, is not increased or scaled up. That is, the opening on one side is suitably enlarged or scaled up to permit ease of assembly of the rubber isolator. The opening on the opposite side is maintained at a smaller size to limit maximum travel of the isolator shaft to the desired level. In the end, the housing design having unequally sized openings, a large one for assembly, and a smaller one for travel restriction, is obtained while incorporating a greater amount of rubber into the assembly.

The smaller opening in the housing also advantageously addresses design problems that might otherwise occur with the embodiments of FIGS. 2, 3, 5, and 6. That is, by strategically orienting the smaller opening 30 in the housing relative to the larger opening 40, the isolator is better retained under axially dislodging forces such as bumper impacts.

It will be appreciated by one skilled in the art that the openings in the housing and likewise the configuration of the rubber isolator may adopt different profiles or shapes. It is not as desirable to provide small openings on both sides of the housing since it then would be difficult to pre-compress the bushing during assembly. Thus, the different openings at opposite ends of the housing also facilitate assembly.

The housing is preferably a stamped material such as steel or aluminum. It can also be a cast structure while the metal shaft (steel or aluminum) is typically bonded to the elastomeric isolator or rubber. In this arrangement, the rubber is not bonded to the outer housing so that the isolator can be preloaded during insertion or installation into the housing.

The invention has been described with reference to the preferred embodiment. Modifications and alterations will occur to others upon reading and understanding this specification. It is intended to include all such modifications and alterations in so far as they come within the scope of the appended claims or the equivalents thereof

1. A bushing assembly comprising:
a shaft;
an isolator received around the shaft; and
a housing having a cavity extending through the housing with first and second different sized openings located at opposite open ends of the housing, the housing cavity dimensioned to receive the isolator therein.

2. The invention of claim 1 wherein the first and second openings are coaxial,

3. (canceled)

4. The invention of claim 1 wherein the openings are similarly configured.

5. The invention of claim 1 wherein the isolator is an elastomer.

6. The invention of claim 1 wherein the housing includes at least first and second portions that are secured together to form the housing.

7. The invention of claim 6 wherein the first housing portion receives the isolator therein and the second housing portion is dimensioned to compress the first housing portion and provide a precompression to the isolator.

8. The invention of claim 1 wherein the first opening is dimensioned to receive the isolator therein and the second opening has a reduced cross-sectional dimension relative to the first opening to counteract dislodging forces exerted on the bushing assembly in the general direction of the first opening toward the second opening.

9. The invention of claim 1 wherein the housing at the first opening serves as a travel limiter that limits maximum displacement of the shaft.

10. The invention of claim 1 wherein the isolator is an elastomer that is bonded to the shaft.

11. The invention of claim 1 wherein the isolator is in press-fit engagement with the housing.

12. A vibration isolator assembly comprising:
a shaft;
a housing disposed in spaced, surrounding relation to the shaft and having different sized openings at first and second opposed open ends thereof; and
an elastomeric isolator received between the shaft and housing for damping vibrations therebetween.

13. (canceled)

14. The invention of claim 12 wherein the openings are similarly configured.

15. The invention of claim 12 wherein the isolator is an elastomer.

16. The invention of claim 12 wherein the housing includes at least first and second portions that are secured together to form the housing.

17. The invention of claim 16 wherein the first housing portion receives the isolator therein and the second housing portion is dimensioned to compress the first housing portion and provide a precompression to the isolator.

18. The invention of claim 12 wherein the first opening is dimensioned to receive the isolator therein and the second opening has a reduced cross-sectional dimension relative to the first opening to counteract dislodging forces exerted on the bushing assembly in the general direction of the first opening toward the second opening.

19. A method of limiting travel of a shaft in a preloaded vibration isolator assembly that includes a housing receiving an isolator that carries the shaft, comprising the steps of:
providing different sized first and second opposed openings at opposed ends of the housing; and
inserting the isolator through the first opening and toward the second opening of the housing.
